(19) United States
(12) Patent Application Publication
(10) Pub. No.: US 2019/0293402 A1
(43) Pub. Date: Sep. 26, 2019

(54) ARM TYPE COORDINATE MEASURING MACHINE

(71) Applicant: MITUTOYO CORPORATION, Kawasaki-shi (JP)

(72) Inventors: Shingo KIYOTANI, Utsunomiya-shi (JP); Kanae KOBAYASHI, Utsunomiya-shi (JP); Tomohiro USUI, Utsunomiya-shi (JP); Tatsuya TERAUCHI, Utsunomiya-shi (JP)

(73) Assignee: MITUTOYO CORPORATION, Kawasaki-shi (JP)

(21) Appl. No.: 16/360,335

(22) Filed: Mar. 21, 2019

(30) Foreign Application Priority Data
Mar. 26, 2018 (JP) 2018-058366

(51) Int. Cl. G01B 5/00; G01B 5/008

(52) U.S. Cl. CPC G01B 5/0004; G01B 5/008

(57) ABSTRACT

An arm type coordinate measuring machine includes a rotating table on which a workpiece is mounted, a probe for measuring three-dimensional coordinates of the workpiece mounted on the rotating table, a support arm that is rotatable while supporting the probe, an arm driving portion configured to rotate the support arm around a first axis, a table driving portion configured to rotate the rotating table around a second axis perpendicular to the first axis, and a control portion configured to drive the arm driving portion and the table driving portion to move the probe with respect to the workpiece such that the three-dimensional coordinates of the workpiece are measured by the probe.

### CROSS-REFERENCE TO RELATED APPLICATION

This application claims priority from Japanese Patent Applications No. 2018-058366 filed on Mar. 26, 2018, the entire subject-matter of which is incorporated herein by reference.

### TECHNICAL FIELD

The present disclosure relates to an arm type coordinate measuring machine that measures a measured subject with a probe.

### BACKGROUND

As a measuring apparatus, for example, a three-dimensional measuring apparatus that moves a probe, for example, three-axis directions perpendicular to each other to measure coordinates or the like of a measured subject mounted on a mounting table is used. A three-dimensional measuring apparatus described in Japanese Unexamined Utility Model Application Publication No. S50-22049 is a so-called double column type measuring apparatus that includes a moving mechanism constituted of moving members moving in an X-axis direction, a Y-axis direction, and a Z-axis direction, respectively, and moves a probe using the moving mechanism.

However, the three-dimensional measuring apparatus of the double column type includes the moving mechanism in which a plurality of moving members are connected, and thus has a limited measurement space where a subject is measured. Therefore, there is a limit on the size or shape of a measured subject that can be measured. In addition, the three-dimensional measuring apparatus of the double column type includes the moving mechanism having a complex structure, and the size thereof increases.

### SUMMARY

An object of the present disclosure is to provide an arm type coordinate measuring machine having a high degree of flexibility in measurement of a measured subject.

According to the present disclosure, there is disclosed an arm type coordinate measuring machine including:

a mounting table on which a measured subject is mounted;

a probe for measuring three-dimensional coordinates of the measured subject mounted on the mounting table;

a supporter being rotatable while supporting the probe;

a first driving portion configured to rotate the mounting table or the supporter around a first axis;

a second driving portion configured to rotate the mounting table or the supporter around a second axis perpendicular to the first axis; and

a control portion configured to drive the first driving portion and the second driving portion to move the probe with respect to the measured subject such that the three-dimensional coordinates of the measured subject are measured by the probe.

The control portion may drive the first driving portion to rotate the supporter around the first axis and may drive the second driving portion to rotate the mounting table around the second axis.

The control portion may drive the first driving portion to rotate the supporter around the first axis and may drive the second driving portion to rotate the supporter around the second axis.

The supporter may be a support arm in which a plurality of links are connected through a joint portion, and

the first driving portion may rotate the joint portion around the first axis.

The first driving portion may rotate the link of the support arm around a third axis being in parallel with an axis direction of the link and intersecting with the first axis or the second axis.

The arm type coordinate measuring machine may further include:

a guide portion configured to guide the support arm to be rotatable around the second axis, the guide portion being provided around the mounting table in an annular shape,

in which the control portion may drive the second driving portion to rotate the support arm along the guide portion.

The support arm may include a first support arm that supports a first probe and a second support arm that supports a second probe different from the first probe, and

the control portion may cause the first probe and the second probe to concurrently measure a plurality of portions of the measured subject.

The arm type coordinate measuring machine may further include:

a guide portion configured to guide the first support arm and the second support arm to be rotatable around the second axis, the guide portion being provided around the mounting table in an annular shape,

in which the control portion may drive the second driving portion to rotate the first support arm and the second support arm along the guide portion.

After the measured subject is measured by the probe, the control portion may drive the first driving portion and the second driving portion to place the support arm at a retraction position where is distant from a measurement space on the mounting table.

The mounting table may be a circular base.

According to the present disclosure, the arm type coordinate measuring machine having a high degree of flexibility in measurement of a measured subject can be realized.

### BRIEF DESCRIPTION OF DRAWINGS

FIG. 1 is a schematic diagram illustrating a configuration of an arm type coordinate measuring machine according to a first embodiment.

FIG. 2 is a block diagram illustrating a driving portion that rotates a rotating table and a support arm.

FIG. 3 is a schematic diagram illustrating a configuration of an arm type coordinate measuring machine according to a second embodiment.

FIG. 4 is a schematic diagram illustrating a configuration of an arm type coordinate measuring machine according to a third embodiment.

FIG. 5 is a schematic diagram illustrating a configuration of an arm type coordinate measuring machine according to a fourth embodiment.

FIG. 6 is a schematic diagram illustrating a configuration of an arm type coordinate measuring machine according to a fifth embodiment.

### DETAILED DESCRIPTION

### First Embodiment

### (Configuration of Arm Type Coordinate Measuring Machine)

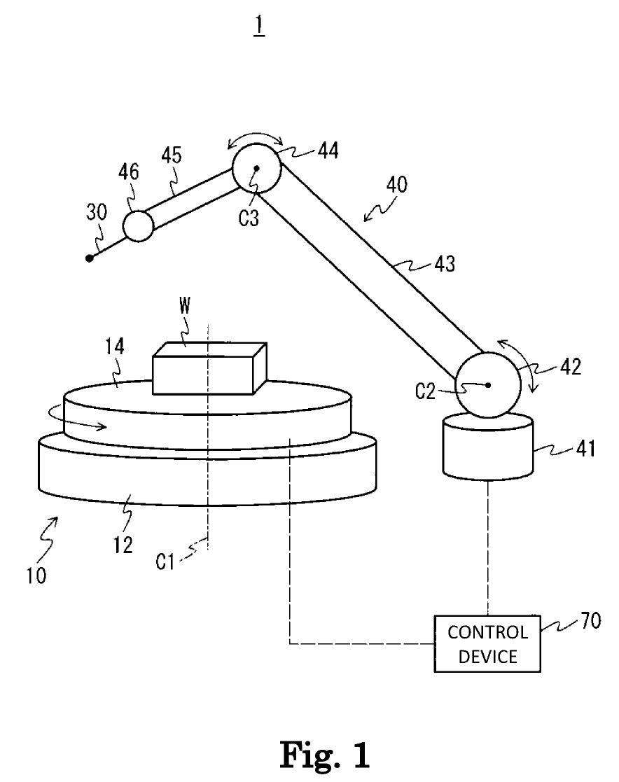

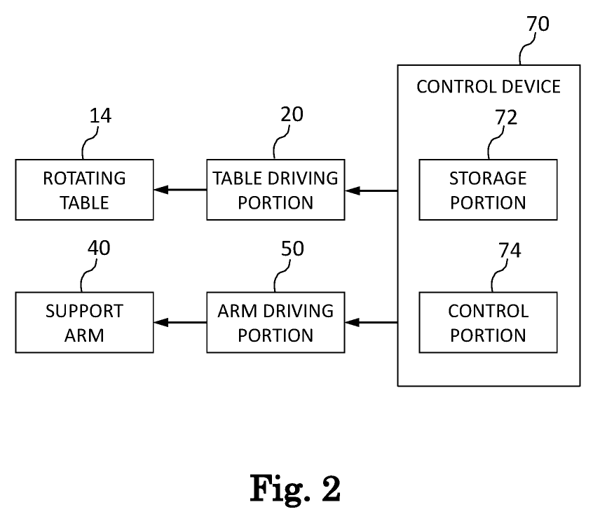

A configuration of an arm type coordinate measuring machine 1 as a three-dimensional measuring apparatus according to a first embodiment will be described with reference to FIGS. 1 and 2.

FIG. 1 is a schematic diagram illustrating a configuration of the arm type coordinate measuring machine 1 according to a first embodiment. FIG. 2 is a block diagram illustrating a driving portion that rotates a rotating table 14 and a support arm 40.

As illustrated in FIGS. 1 and 2, the arm type coordinate measuring machine 1 includes a mounting table 10, a table driving portion 20, a probe 30, a support arm 40, an arm driving portion 50, and a control device 70. Although the details will be described below, the arm type coordinate measuring machine 1 can rotate a workpiece W using the mounting table 10, control a position of the probe 30 using the support arm 40, and measure the coordinates of the workpiece W using the prove 30. In the first embodiment, the arm driving portion 50 corresponds to the first driving portion, and the table driving portion 20 corresponds to the second driving portion.

The mounting table 10 is a table on which the workpiece W as a measured subject is mounted. The mounting table 10 is formed, for example, in a circular shape (that is, a cylindrical shape). By forming the mounting table 10 in a cylindrical shape, the installation space of the mounting table 10 can be reduced as compared to a case where the mounting table 10 is formed in a rectangular shape. The mounting table 10 is configured to rotate the mounted workpiece W around a rotation axis C1 to be positioned at any position. As illustrated in FIG. 1, the mounting table 10 includes a base portion 12 and the rotating table 14.

The base portion 12 is formed in a circular shape. The base portion 12 is a portion that supports the rotating table 14 to be rotatable.

The workpiece W is mounted on the rotating table 14. Like the base portion 12, the rotating table 14 is formed in a circular shape. The diameter of the rotating table 14 is less than that of the base portion 12.

The table driving portion 20 has a function of rotating the rotating table 14 around the rotation axis C1 (corresponding to the second axis). For example, the table driving portion 20 includes a driving source such as a motor. The table driving portion 20 rotates the rotating table 14 around the rotation axis C1 using driving force generated from the driving source. By rotating the rotating table 14 as described above, the position of the workpiece W is controlled.

The probe 30 is a probe for measuring three-dimensional coordinates of the workpiece W mounted on the mounting table 10 (specifically, the rotating table 14). The probe 30 is supported at a tip of the support arm 40. For example, the probe 30 scans a three-dimensional position of the workpiece W by moving in contact with the workpiece W.

The support arm 40 is an arm mechanism in which a plurality of links are connected through a joint portion. As illustrated in FIG. 1, the support arm 40 includes a support column 41, a first joint portion 42, a first link 43, a second joint portion 44, a second link 45, and a head portion 46. The support arm 40 holds the probe 30, and rotates it.

The support column 41 is a base portion of the support arm 40. The support column 41 is disposed around the mounting table 10.

The first joint portion 42 is supported by the support column 41 to be rotatable around a rotation axis C2 (axis perpendicular to the plane of FIG. 1).

One end of the first link 43 in a longitudinal direction is connected to the first joint portion 42, and another end of the first link 43 in the longitudinal direction is connected to the second joint portion 44. The first link 43 rotates in conjunction with rotation of the first joint portion 42 in a direction indicated by an arrow in FIG. 1.

The second joint portion 44 is rotatable around a rotation axis C3 (axis perpendicular to the plane of FIG. 1). Here, the rotation axis C3 is in parallel with the rotation axis C2.

One end of the second link 45 in a longitudinal direction is connected to the second joint portion 44, and another end of the second link 45 in the longitudinal direction is connected to the head portion 46. The second link 45 rotates in conjunction with rotation of the second joint portion 44 in a direction indicated by an arrow in FIG. 1.

The head portion 46 supports the probe 30.

The arm driving portion 50 has a function of rotating the support arm 40 that supports the probe 30. For example, the arm driving portion 50 includes a driving source such as a motor. The arm driving portion 50 rotates the first joint portion 42 and the second joint portion 44 around the rotation axes C2 and C3. That is, the first link 43 and the second link 45 rotate around the rotation axes C2 and C3, respectively. As a result, the position of the probe 30 is controlled.

The control device 70 controls the operation of the arm type coordinate measuring machine 1. The control device 70 executes a movement control of the probe 30 or executes shape analysis of the workpiece W based on the measurement result using the probe 30. As illustrated in FIG. 2, the control device 70 includes a storage portion 72 and a control portion 74.

The storage portion 72 stores programs to be executed by the control portion 74 or various data.

The control portion 74 executes the program stored in the storage portion 72 to control the arm type coordinate measuring machine 1.

When the workpiece W is measured by the probe 30, the control portion 74 drives the table driving portion 20 and the arm driving portion 50. For example, the control portion 74 drives the table driving portion 20 and the arm driving portion 50 to move the probe 30 with respect to the workpiece W on the rotating table 14 of the mounting table 10 such that the three-dimensional coordinates of the workpiece W on the rotating table 14 are measured by the probe 30.

The control portion 74 drives the table driving portion 20 to rotate the rotating table 14 on which the workpiece W is mounted around the rotation axis C1. The control portion 74 drives the arm driving portion 50 to rotate the support arm 40 around the rotation axes C2 and C3. Specifically, the control portion 74 drives the arm driving portion 50 to rotate the first joint portion 42 and the second joint portion 44 around the rotation axes C2 and C3 such that the first link 43 and the second link 45 rotate around the rotation axes C2 and C3.

After the workpiece W is measured by the probe 30, the control portion 74 drives the arm driving portion 50 to place the support arm 40 at a retraction position where is distant from a measurement space on the rotating table 14. When the support arm 40 is placed at the retraction position, for example, the entire support arm 40 is positioned outside the measurement space on the rotating table 14. When the support arm 40 is being placed at the retraction position, the control portion 74 may cause the first link 43 and the second link 45 to be folded. As a result, an occupancy space of the support arm 40 placed at the retraction position can be reduced. By placing the support arm 40 at the retraction position as described above, the workpiece W can be easily placed before the measurement of the workpiece W, and the workpiece W can be easily removed after the measurement of the workpiece W. When the support arm 40 is being placed at the retraction position, the control portion 74 may cause the rotating table 14 to rotate to a position where the workpiece W can be easily removed.

### Effects of First Embodiment

The arm type coordinate measuring machine 1 according to the first embodiment includes: the table driving portion 20 that rotates the rotating table 14 on which the workpiece W is mounted; and the arm driving portion 50 that rotates the support arm 40 supporting the probe 30. The arm type coordinate measuring machine 1 drives the table driving portion 20 and the arm driving portion 50 to move the probe 30 with respect to the workpiece W, and measures the three-dimensional coordinates of the workpiece W with the probe 30.

As a result, the rotatable support arm 40 moves the probe 30 such that the probe 30 can be easily moved to various positions of the measurement space on the rotating table 14. In particular, in a case where a double column type moving mechanism that extends over the measurement space is used, the space where the workpiece W can be mounted is likely to be limited. However, by using the support arm 40 as in the present embodiment, the measurement space can be effectively used.

In a case where the shape of the workpiece W is complex and a portion of the workpiece W to which it is difficult to move the probe 30 is measured, the measurement by the probe 30 can be easily performed by rotating the rotating table 14 on which the workpiece W is supported.

### Second Embodiment

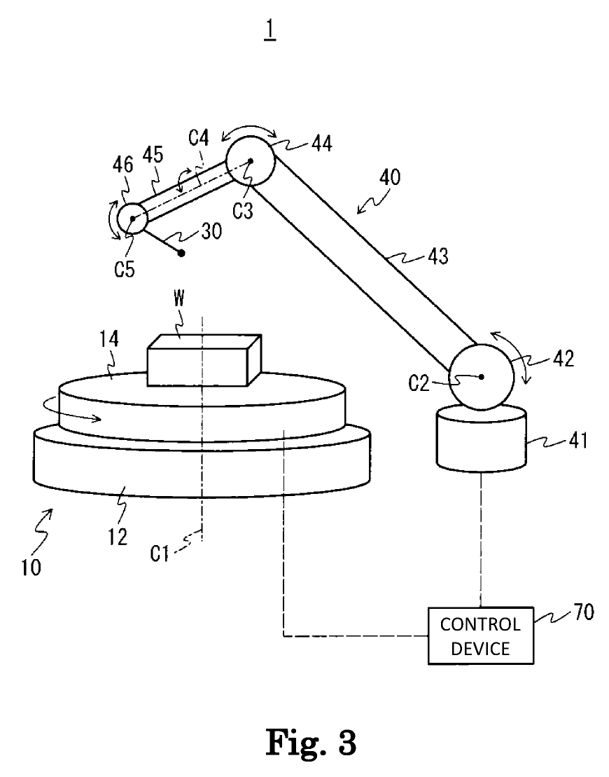

FIG. 3 is a schematic diagram illustrating a configuration of an arm type coordinate measuring machine 1 according to a second embodiment.

The second embodiment is different from the first embodiment in the configurations of the second link 45 and the head portion 46 in the support arm 40. Since other configurations of the second embodiment other than the second link 45 and the head portion 46 are the same as those of the first embodiment, the detailed description thereof will not be repeated.

As illustrated in FIG. 3, the second link 45 is rotatable around a rotation axis C4 that is in parallel with an axis direction of the second link 45 and intersects with the rotation axis C3. The arm driving portion 50 rotates the second link 45 around the rotation axis C4 using the driving force. By rotating the second link 45 around the rotation axis C4 as described above, the direction of the probe 30 can be more easily adjusted as compared to the first embodiment.

As illustrated in FIG. 3, the head portion 46 is rotatable around a rotation axis C5 (axis perpendicular to the plane of FIG. 3). The probe 30 supported by the head portion 46 rotates in conjunction with rotation of the head portion 46. As a result, the direction of the probe 30 can be easily adjusted. Here, the rotation axis C5 is in parallel with the rotation axis C3.

The rotation of the second link 45 and the head portion 46 is performed by the arm driving portion 50 (FIG. 2) that receives an instruction from the control device 70. As a result, the arm driving portion 50 can adjust the probe 30 supported by the support arm 40 in various directions relative to the workpiece W.

### Third Embodiment

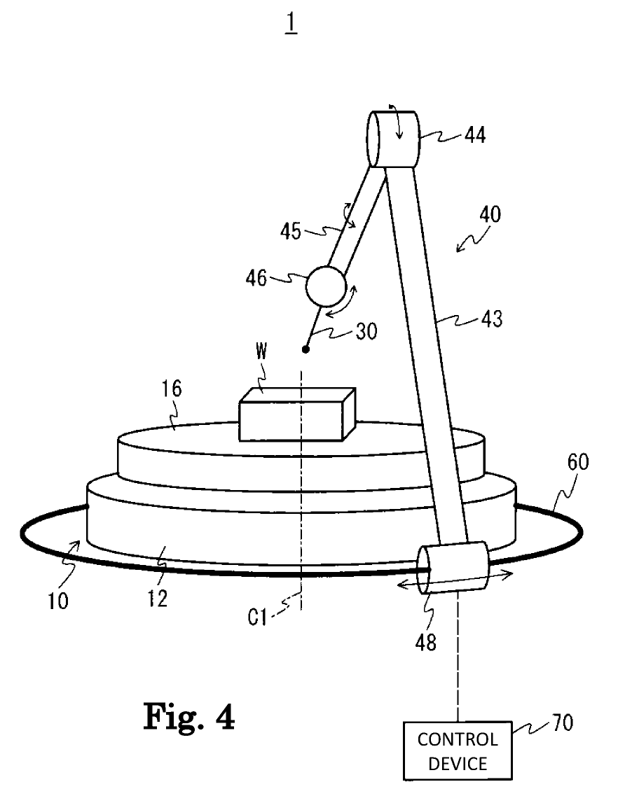

FIG. 4 is a schematic diagram illustrating a configuration of an arm type coordinate measuring machine 1 according to a third embodiment.

The third embodiment is different from the second embodiment in that the entire support arm 40 is rotatable around the mounting table 10. Unlike the rotating table 14 according the second embodiment, a table 16 of the third embodiment is fixed to the base portion 12 without being rotated.

In the third embodiment, a guide portion 60 illustrated in FIG. 4 is provided. The guide portion 60 is provided around the base portion 12 of the mounting table 10 in an annular shape or an arc shape. The guide portion 60 guides the support arm 40 to be rotatable around the rotation axis C1.

In the support arm 40, a moving portion 48 is provided instead of the support column 41 and the first joint portion 42 illustrated in FIG. 3. One end of the first link 43 in the longitudinal direction is connected to the moving portion 48. The moving portion 48 moves along the guide portion 60 such that the entire support arm 40 rotates around the rotation axis C1.

The rotation of the moving portion 48 around the rotation axis C1 is performed by the arm driving portion 50 (FIG. 2) that receives an instruction from the control device 70. Therefore, in the third embodiment, the arm driving portion 50 functions as the first driving portion and the second driving portion. The configurations that are not described in the third embodiment are the same as those of the second embodiment in FIG. 3.

In the third embodiment, the table 16 is fixed, whereas the support arm 40 is rotated around the rotation axis C1. As a result, the degree of flexibility in the measurement of the workpiece W by the probe 30 increases as in the second embodiment in which the rotating table 14 is rotated around the rotation axis C1.

In the above description, the table 16 of the mounting table 10 is fixed to the base portion 12, but the present embodiment is not limited thereto. For example, the table 16 may rotate around the rotation axis C1 like the rotating table 14 illustrated in FIG. 1.

As in the second embodiment, the head portion 46 of the support arm 40 may be configured to be rotatable around the rotation axis C5 (refer to FIG. 4).

### Fourth Embodiment

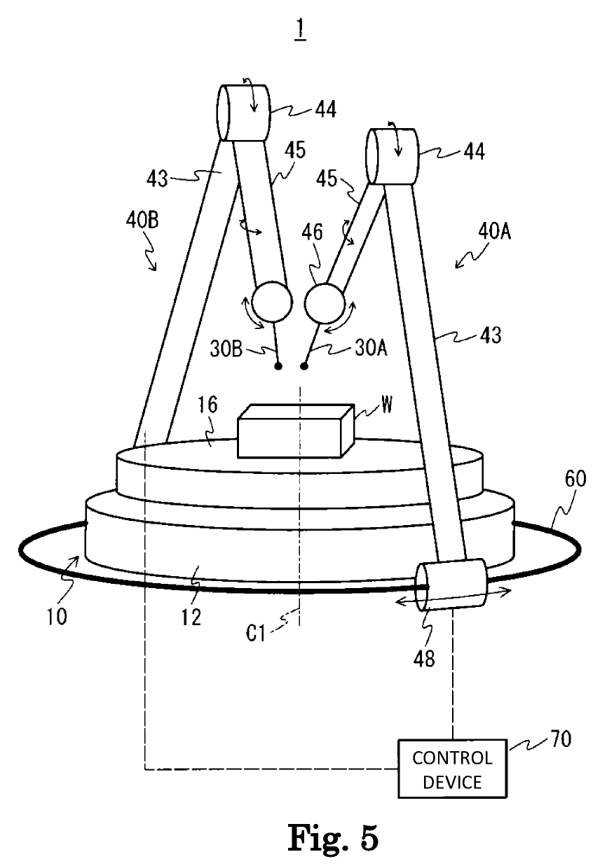

FIG. 5 is a schematic diagram illustrating a configuration of an arm type coordinate measuring machine 1 according to a fourth embodiment.

The fourth embodiment is different from the third embodiment, in that the arm type coordinate measuring machine 1 includes two probes 30A and 30B and two support arms 40A and 40B illustrated in FIG. 5. The probes 30A and 30B and the support arms 40A and 40B have the same configurations as the probe 30 and the support arm 40 in the third embodiment, respectively. In the fourth embodiment, the probe 30A corresponds to the first probe, and the probe 30B corresponds to the second probe. The support arm 40A corresponds to the first support arm, and the support arm 40B corresponds to the second support arm.

The two probes 30A and 30B measure the workpiece W on the table 16 of the mounting table 10. For example, the probes 30A and 30B concurrently measure a plurality of portions of the workpiece W. As a result, the measurement time of the workpiece W can be reduced as compared to a case where the workpiece W is measured by one probe.

The two support arms 40A and 40B rotate around the rotation axis C1 through the guide portion 60 that is provided around the mounting table 10 in an annular shape. The support arms 40A and 40B are located apart in a circumferential direction by 180 degrees.

The control device 70 drives the arm driving portion 50 (FIG. 2) to rotate the support arms 40A and 40B along the guide portion 60. Rotation directions of the support arms 40A and 40B may be the same as each other or opposite to each other depending on the measurement position of the workpiece W. By rotating the support arms 40A and 40B as described above, the probes 30A and 30B can rapidly measure the workpiece W.

In the fourth embodiment, by controlling the support arm 40A and the support arm 40B together, the measurement operation of the workpiece W can be performed within a short period of time.

In the fourth embodiment, by providing the two support arms 40A and 40B, the length of each of the support arm 40A and the support arm 40B can be made to be shorter than the length of the support arm 40 described in the first to third embodiment. As a result, the size of the entire apparatus can be reduced.

FIG. 5 illustrates the support arm 40A and the support arm 40B as the same size, but the present embodiment is not limited thereto. The support arm 40A and the support arm 40B may have different sizes. For example, the length of the support arm 40A may be less than the length of the support arm 40B. In this case, the external size may be measured using the support arm 40A, and the minute dimensions of the workpiece W may be measured using the support arm 40B.

FIG. 5 illustrates the probes 30A and 30B as the same kind (specifically, a contact probe), but the present embodiment is not limited thereto. For example, the probe 30A maybe a contact probe, and the probe 30B may a non-contact probe.

In the above description, the support arm 40A and the support arm 40B are rotatably guided by the guide portion 60, but the present embodiment is not limited thereto. For example, the support arm 40A may be guided to be rotatable by the guide portion 60, and the support arm 40B may be supported by the support column 41 (FIG. 1) described in the first embodiment.

### Fifth Embodiment

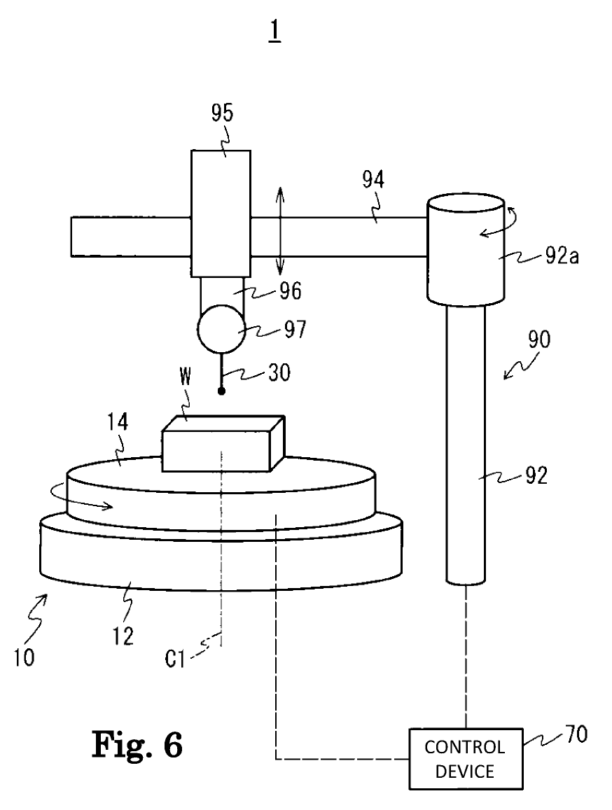

FIG. 6 is a schematic diagram illustrating a configuration of an arm type coordinate measuring machine 1 according to a fifth embodiment.

The arm type coordinate measuring machine 1 according to the fifth embodiment includes a support mechanism 90 instead of the support arm 40 described in the first embodiment. As illustrated in FIG. 6, the support mechanism 90 includes a support column 92, a connection portion 94, a moving portion 95, a ram shaft 96, and a head portion 97. Since the configuration of the mounting table 10 is the same as that of the first embodiment, the description thereof will not be repeated.

The support column 92 is disposed outside the mounting table 10 along a vertical direction. An upper portion 92a is rotatable around the support column 92. The connection portion 94 is provided in a beam shape and is connected to the upper portion 92a of the support column 92. The connection portion 94 rotates in conjunction with rotation of the upper portion 92a. The moving portion 95 moves along a longitudinal direction of the connection portion 94. The ram shaft 96 is movable in the vertical direction relative to the moving portion 95. The head portion 97 is provided at a tip of the ram shaft 96 and supports the probe 30.

Even in the fifth embodiment, by moving the rotating table 14 on which the workpiece W is mounted and the probe 30, the degree of flexibility in the measurement of the workpiece W by the probe 30 increases.

In the above-described embodiments, the probe 30 is a contact probe coming into contact with the workpiece W, but the present disclosure is not limited thereto. For example, the probe 30 may be a non-contact probe such as a laser or a camera.

In the above description, the rotating table 14 has a circular shape (cylindrical), but the present disclosure is not limited thereto. For example, the rotating table 14 may be polygonal.

Hereinabove, the embodiments of the present disclosure have been described. However, the technical scope of the present disclosure is not limited to the scope described in the embodiments, and various modifications and changes can be made within the scope. For example, specific embodiments of distribution and integration of the devices are not limited to the above-described embodiments. All or a portion of the devices may be configured by functionally or physically distributing or integrating the devices in arbitrary units. In addition, new embodiments created by arbitrary combinations of the embodiments are also included in the embodiments of the present disclosure. Effects of the new embodiments created by the combinations also have the effects of the original embodiments.

What is claimed is:

1. An arm type coordinate measuring machine comprising:
a mounting table on which a measured subject is mounted;
a probe for measuring three-dimensional coordinates of the measured subject mounted on the mounting table;
a supporter being rotatable while supporting the probe;
a first driving portion configured to rotate the mounting table or the supporter around a first axis;
a second driving portion configured to rotate the mounting table or the supporter around a second axis perpendicular to the first axis; and
a control portion configured to drive the first driving portion and the second driving portion to move the probe with respect to the measured subject such that the three-dimensional coordinates of the measured subject are measured by the probe.

2. The arm type coordinate measuring machine according to claim 1,
wherein the control portion drives the first driving portion to rotate the supporter around the first axis and drives the second driving portion to rotate the mounting table around the second axis.

3. The arm type coordinate measuring machine according to claim 1,
wherein the control portion drives the first driving portion to rotate the supporter around the first axis and drives the second driving portion to rotate the supporter around the second axis.

4. The arm type coordinate measuring machine according to claim 1,
wherein the supporter is a support arm in which a plurality of links are connected through a joint portion, and
the first driving portion rotates the joint portion around the first axis.

5. The arm type coordinate measuring machine according to claim 4,
wherein the first driving portion rotates the link of the support arm around a third axis being in parallel with an axis direction of the link and intersecting with the first axis or the second axis.

6. The arm type coordinate measuring machine according to claim 5, further comprising:
a guide portion configured to guide the support arm to be rotatable around the second axis, the guide portion being provided around the mounting table in an annular shape,
wherein the control portion drives the second driving portion to rotate the support arm along the guide portion.

7. The arm type coordinate measuring machine according to claim 4,
wherein the support arm includes a first support arm that supports a first probe and a second support arm that supports a second probe different from the first probe, and
the control portion causes the first probe and the second probe to concurrently measure a plurality of portions of the measured subject.

8. The arm type coordinate measuring machine according to claim 7, further comprising:
a guide portion configured to guide the first support arm and the second support arm to be rotatable around the second axis, the guide portion being provided around the mounting table in an annular shape,
wherein the control portion drives the second driving portion to rotate the first support arm and the second support arm along the guide portion.

9. The arm type coordinate measuring machine according to claim 1,
wherein after the measured subject is measured by the probe, the control portion drives the first driving portion and the second driving portion to place the support arm at a retraction position where is distant from a measurement space on the mounting table.

10. The arm type coordinate measuring machine according to claim 1, wherein the mounting table is a circular base.
